(19) United States
(12) Patent Application Publication
(10) Pub. No.: US 2014/0327602 A1
(43) Pub. Date: Nov. 6, 2014

(54) VIRTUAL IMAGE DISPLAY APPARATUS

(71) Applicant: SEIKO EPSON CORPORATION, Tokyo (JP)

(72) Inventor: Noriaki HIRAIDE, Azumino-Shi (JP)

(73) Assignee: SEIKO EPSON CORPORATION, Tokyo (JP)

(21) Appl. No.: 14/260,789

(22) Filed: Apr. 24, 2014

(30) Foreign Application Priority Data
May 1, 2013 (JP) 2013-096199

(51) Int. Cl. G02B 27/01

(52) U.S. Cl. CPC G02B 27/0172; G02B 2027/0178
USPC 345/8

(57) ABSTRACT

A rim portion or the like functioning as a boundary portion is arranged in a position corresponding to an interpupillary distance of an observer. Therefore, it is possible to cause a non-observer looking at the observer wearing a virtual image display apparatus from the outside to recognize that an outer frame portion is present in an appropriate position in terms of an eyeglass shape. It is possible to reduce a sense of discomfort given to the non-observer. Since the boundary portion is present in an appropriate position in terms of an eyeglass shape, a visual field same as a visual field obtained when the eyeglasses are worn is secured. Therefore, it is possible to sufficiently secure a visual field range for the observer in see-through.

### BACKGROUND

1. Technical Field

The present invention relates to a virtual image display apparatus that presents a video formed by a video display apparatus to an observer and, more particularly, to a virtual image display apparatus suitable for a head mounted display mounted on the head of the observer.

2. Related Art

Various virtual image display apparatuses are proposed as a virtual image display apparatus such as a head mounted display (hereinafter also referred to as HMD) mounted on the head of an observer (see, for example, JP-A-2012-163640 (Patent Literature 1)).

The virtual image display apparatus such as the HMD is desired to attain an increase in an angle of view without deteriorating image quality while being reduced in size and weight. If the virtual image display apparatus covers the entire visual field of the observer to allow the observer to see only video light, the observer cannot see a state of the outside world and feels uneasiness. Anew use such as virtual reality is created by superimposing and displaying the outside world and a video and allowing the observer to see the video through the outside world. Therefore, there is a demand for a display that displays video image light to be superimposed on the outside world without hindering a visual field of the outside world.

Taking into account the situation explained above, a transparent light guide device arranged in front of the eyes of the observer by see-through is used. Consequently, it is possible to form a virtual image display apparatus in a form close to eyeglasses, improve a wearing feeling, and improve an apparent form. In this case, it is conceivable that an optical system for causing the observer to visually recognize an image has, for example, a form for guiding video light formed by a liquid crystal display panel arranged on a head side surface of the observer and a projection optical device to the front of the eyes using a transparent prism (see Patent Literature 1).

Concerning a form of the eyeglasses, the eyeglasses need to cover the eye sockets in an appropriate range. Further, there is an ideal balanced shape including a position, a range, a size, and the like of the eyeglasses with respect to the face (in particular, the eyes) of a person in a wearing state of the eyeglasses. If the shape of the eyeglasses deviates from the ideal balanced shape, a person looking at the observer wearing the virtual image display apparatus from the outside (hereinafter also referred to as “non-observer”; including the observer looking at himself/herself in a mirror) feels a sense of discomfort. For example, if a frame of the eyeglasses is too large with respect to an interpupillary distance, the person feels as if the eyes are relatively close to the center side with respect to the frame and receives an impression that the eyeglasses are mismatched or do not suit the observer. As a result of trial and errors, the inventor confirmed that, although the HMD and the eyeglasses are different in an optical function, a transparent HMD having a form close to the form of the eyeglasses gives the same impression as the eyeglasses, for example, when a frame of the HMD is excessively large. Therefore, it is desirable that the size of the frame of the transparent HMD is adjusted according to the position of the eyes of the observer and does not cause the non-observer to feel a sense of discomfort.

However, for example, as in Patent Literature 1, in the case of the configuration in which the video display apparatus and the projection optical system are arranged in the side head of the observer, the apparatus tends to further project to the outer side than the side head. In the case of the see-through configuration, in the lateral direction in which the eyes of the observer range, from the viewpoint of securing a visual field, it is desired to form a see-through portion as large as possible not only on the inner side but also on the outer side of the eyes of the observer. That is, the apparatus tends to be large in the lateral direction.

### SUMMARY

An advantage of some aspects of the invention is to provide a virtual image display apparatus that can keep a balance in terms of a shape close to the shape of the eyeglasses while securing a visual field range in see-through and suppress a sense of discomfort given to the non-observer.

An aspect of the invention is directed to a virtual image display apparatus including: a video device; a light guide device arranged in front of the eyes of an observer and configured to guide light emitted by the video device to the eyes of the observer and cause the observer to visually recognize an image; and an opening defining section provided to correspond to the light guide device and configured to define a region having a first opening width extending in the lateral direction in which the eyes of the observer range and a second opening width extending in the longitudinal direction perpendicular to the lateral direction, enable the eyes of the observer to be visually recognized from the outside, and cause the observer to visually recognize a relative position to the eyes of the observer. The virtual image display apparatus includes, as at least a part of the opening defining section, a boundary portion arranged in at least a position on a side head side of the observer in the lateral direction in which the eyes of the observer range, the position being derived from a reference value of an interpupillary distance of the observer, extending while having a component in the longitudinal direction perpendicular to the lateral direction in which the eyes of the observer range, and configured to define an outer end of the first opening width. The region having the first and second opening widths defined by the opening defining section indicates a range in an external appearance, that is, an apparent range.

The virtual image display apparatus causes the observer to visually recognize a relative position to the eyes of the observer as if, for example, a region (a range) formed to surround the eyes by the opening defining section configured by members arranged around the eyes of the observer such as a frame that supports the light guide device and a cover-like member for protecting a part of the light guide device, the video device, or the like is a rim portion of a normal eyeglass frame or a normal eyeglass lens. When the region (the range) formed by the opening defining section and having the first and second opening widths respectively in the longitudinal and lateral directions is recognized like the eyeglass frame or the like, the position and the size of the region (the range) with respect to the eyes are appropriate. Therefore, the external appearance of the virtual image display apparatus can be prevented from being deteriorated. In the virtual image display apparatus, the boundary portion is arranged in the position corresponding to the reference value of the interpupillary distance of the observer, the position being an appropriate position on the side head side, that is, the outer side of the eyes. The boundary portion defines an outer end of the first opening width extending in the lateral direction in which the eyes of the observer range in the region (the range) formed by the opening defining section. Consequently, is possible to cause, for example, a non-observer looking at the observer wearing the virtual image display apparatus shaped like the eyeglasses from the outside to recognize as if the region defined by the opening defining section is present in an appropriate position. It is possible to reduce a sense of discomfort given to the non-observer. Since the boundary portion is present in an appropriate position in terms of an eyeglass shape, a visual field same as a visual field obtained when the eyeglasses are worn is secured. Therefore, it is possible to sufficiently secure a visual field range for the observer in see-through.

In a specific aspect of the invention, in an eye front portion of the light guide device, the boundary portion is formed on a surface on a side close to the eyes of the observer when the virtual image display apparatus is worn. In this case, for example, it is possible to, while forming the boundary portion on the side close to the eyes of the observer, sufficiently secure a visual field range on a side far from the eyes of the observer in see-through.

In another aspect of the invention, the light guide device includes a contour portion serving as an eyeglass lens-like shape having a predetermined thickness and includes a first lens surface located on a side far from the eyes of the observer when the virtual image display apparatus is worn and a second lens surface located on a side close to the eyes, and the boundary portion is configured by a rim portion serving as a boundary between the second lens surface and a surface adjacent thereto on the side head side of the observer in a contour portion of the second lens surface. In this case, for example, the boundary portion can be formed in a position suitable for the position of the eyes of the observer by a rim portion of the second lens surface located on the inner side.

In still another aspect of the invention, the light guide device includes a pair of eyeglass lens-like shape portions symmetrical with respect to a center axis passing a center section arranged in the position of the nose of the observer when the virtual image display apparatus is worn and satisfies the following conditional expression concerning an inter-lens center distance FPD2 concerning the second lens surface represented by a sum of a bridge width BW, which is an inter-lens distance in the symmetrical pair of eyeglass lens-like shape portions, and a lens width W2 of the second lens surface and a reference value PD of the interpupillary distance of the observer.

FPD2−PD≦10 mm

In this case, on the second lens surface on which the boundary portion is formed according to the reference value PD of the interpupillary distance of the observer, the inter-lens center distance FPD2 is an appropriate length in terms of the eyeglass shape. Therefore, it is possible to cause the non-observer to feel as if the virtual image display apparatus having the eyeglass shape has a shape and a size not causing a sense of discomfort.

In yet another aspect of the invention, the light guide device satisfies all of the following conditional expressions concerning a bridge width BW, a lens width W1 of the first lens surface, a lens width W2, an inter-lens center distance FPD1 concerning the first lens surface represented by a sum of the bridge width BW and the lens width W1, and the reference value PD of the interpupillary distance of the observer.

5 mm≦BW≦20 mm

40 mm≦W1≦70 mm

40 mm≦W2≦60 mm

FPD1−PD≦10 mm

In this case, the light guide device has the appropriate inter-lens center distances FPD1 and FPD2 in terms of the eyeglass shape according to the reference value PD of the interpupillary distance and has appropriate bridge width BW and lens widths W1 and W2. Therefore, when the virtual image display apparatus is regarded as an eyeglass-shaped member, the virtual image display apparatus has a shape and a size not causing a sense of discomfort in the lateral direction in which the eyes range, that is, a direction in which the first opening width extends.

In still yet another aspect of the invention, the light guide device satisfies the following conditional expression concerning a lens height LH.

20 mm≦LH≦45 mm

In this case, the virtual image display apparatus has a shape and a size not causing a sense of discomfort in the longitudinal direction perpendicular to the lateral direction in which the eyes range, that is, a direction in which the second opening width extends.

In further another aspect of the invention, in the light guide device, a surface located on the side head side of the observer in a surface connecting the first lens surface and the second lens surface is an inclined surface machined at a chamfer angle from the first lens surface to the second lens surface to incline from the side head side to the nose side of the observer, and a rim portion on the side head side of the observer in the first lens surface is located further on the outer side than the rim portion on the side head side of the observer in the second lens surface. In this case, by machining the inclined surface at the chamfer angle, it is possible to provide a difference between the position of the rim portion of the first lens surface and the position of the rim portion of the second lens surface when the observer wearing the apparatus is viewed from the front and, while forming the boundary portion with the rim portion of the second lens surface present on the inner side, keep a visual field range in see-through in a wide state with the rim portion of the first lens surface present on the outer side.

In still further another aspect of the invention, the light guide device emits a video light in a state in which a video optical axis of the video light is adjusted at a tilt angle to tilt in a direction corresponding to a lower side for the observer from a front view direction corresponding to the front of the eyes of the observer, and in the light guide device, the chamfer angle is adjusted according to the tilt angle. The front view direction refers to the front direction for the observer. For example, when the observer views the front in a state in which the observer sits straight or stands, the horizontal direction is the front view direction. The front view direction is decided according to, for example, a relative arrangement relation between the positions and the shapes of members that are in contact with the ears and the nose of the observer when the observer wears the virtual image display apparatus and the positions and the like of an optical system such as the light guide device based on optical design. In this case, when the virtual image display apparatus is worn, it is possible to cause the direction of the eye line of observer to be naturally directed to the lower side for the observer and cause the observer to observe the lower side. Compared with when the observer performs observation in a state in which the observer faces the front view direction, it is possible to reduce a burden on the eyes of the observer. In such a wearing state, it is possible to form the boundary portion in an appropriate position and reduce a sense of discomfort for the non-observer.

In yet further another aspect of the invention, the opening defining section includes a member arranged to surround the eyes of the observer and forms, with the member, a pseudo opening window, which is a pseudo window indicating a region having the first and second opening widths. In this case, it is possible to reduce a sense of discomfort given to the non-observer by controlling the first and second opening widths in the pseudo opening window with the opening defining section.

In still yet further another aspect of the invention, the boundary portion includes any one of an end portion of a cover section configured to house a part of the light guide device, an end portion of an armor case, and a portion serving as a boundary between a plurality of surfaces forming the surface of the light guide device. In this case, it is possible to form the boundary portion without providing a new member.

In a further aspect of the invention, the virtual image display apparatus further includes a frame section including a frame extending in the lateral direction in which the eyes of the observer range and configured to support the light guide device from an upper side and a protector extending in the lateral direction in which the eyes of the observer range and configured to support the light guide device from a lower side, the frame section defining at least a part of the second opening width with the frame and the protector. In this case, the frame section including the frame and the protector defines the position and the size of a region recognized as a range surrounding the eyes in conjunction with the boundary portion. Therefore, it is possible to cause the observer to recognize that the region is present in an appropriate position.

In a still further aspect of the invention, the light guide device includes a light guide member forming a half mirror surface and configured to reflect light emitted from the video device to the eyes of the observer and a light transmitting member arranged integrally with the light guide member on the outer side of the half mirror surface and configured to set visibility to external light to about 0 and present the external light and video light to the observer to be superimposed. In this case, it is possible to make it possible to superimpose the external light and the video light with the integrated light guide member and light transmitting member. It is possible to form the light guide device, for example, in a lens shape.

### BRIEF DESCRIPTION OF THE DRAWINGS

The invention will be described with reference to the accompanying drawings, wherein like numbers reference like devices.

FIG. 1 is a perspective view for simply explaining the external appearance of a virtual image display apparatus in an embodiment of the invention.

FIG. 2A is an external perspective view of the virtual image display apparatus.

FIG. 2B is a perspective view showing the internal structure of the virtual image display apparatus excluding a frame and an armor member.

FIGS. 3A and 3B are perspective views for explaining the external appearances of a light guide device and an optical member incorporated in a first display apparatus.

FIG. 3C is a diagram of a rear surface side showing a rim portion of the light guide device.

FIG. 4A is a perspective view showing a state in which the armor member and the like are excluded to explain the structure of the first display apparatus in the virtual image display apparatus.

FIG. 4B is a side sectional view for explaining the structures of an image display device and a projection lens incorporated in the first display apparatus.

FIG. 5 is a sectional view in a vertically symmetrical surface of the first display apparatus configuring the virtual image display apparatus.

FIG. 6 is a front view showing a positional relation between the virtual image display apparatus and the eyes of an observer.

FIG. 7A is a front view of a wearing state of the virtual image display apparatus.

FIG. 7B is a front view of an optical reference of the virtual image display apparatus.

### DESCRIPTION OF EXEMPLARY EMBODIMENTS

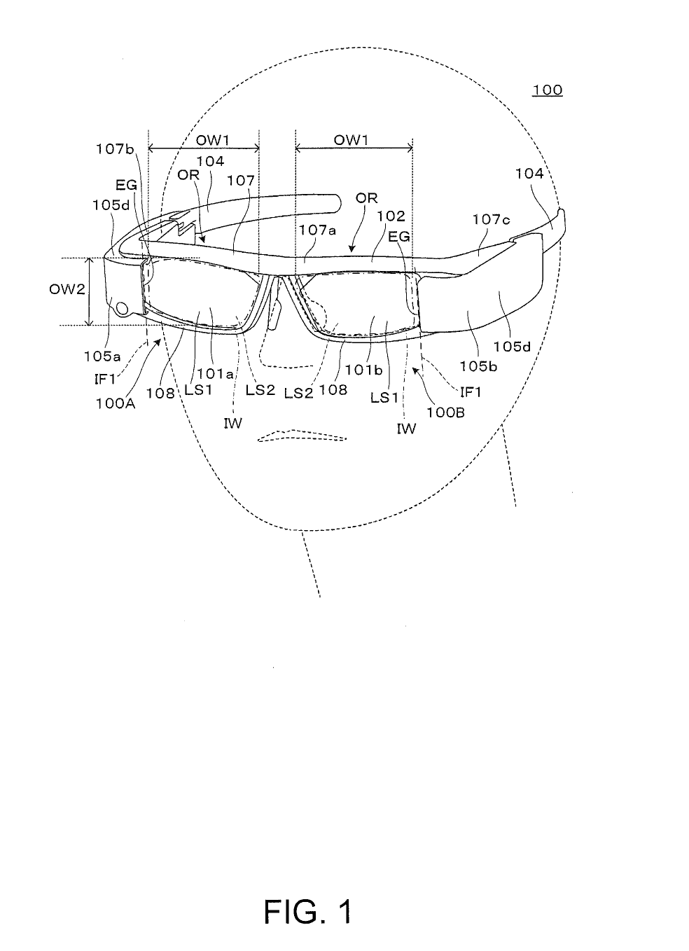

A virtual image display apparatus according to an embodiment of the invention is explained in detail below with reference to FIG. 1 and the like.

As shown in FIG. 1, a virtual image display apparatus 100 in this embodiment is a head mounted display having an external appearance like eyeglasses. The virtual image display apparatus 100 can cause an observer or a user wearing the virtual image display apparatus 100 to visually recognize image light formed by a virtual image and can cause the observer to visually recognize or observe an external image by see-through. The virtual image display apparatus 100 includes first and second optical members 101a and 101b configured to cover the front of the observer to be seen through, a frame section 102 configured to support the optical members 101a and 101b, and first and second image forming main body sections 105a and 105b added to portions from left and right ends of the frame section 102 to temple portions (temples) 104 in the back. A first display apparatus 100A formed by combining the first optical member 101a and the first image forming main body section 105a on the left side on the figure is a portion for forming a virtual image for the right eye and independently functions as a virtual image display apparatus. A second display apparatus 100B formed by combining the second optical member 101b and the second image forming main body section 105b on the right side on the figure is a portion for forming a virtual image for the left eye and independently functions as a virtual image display apparatus.

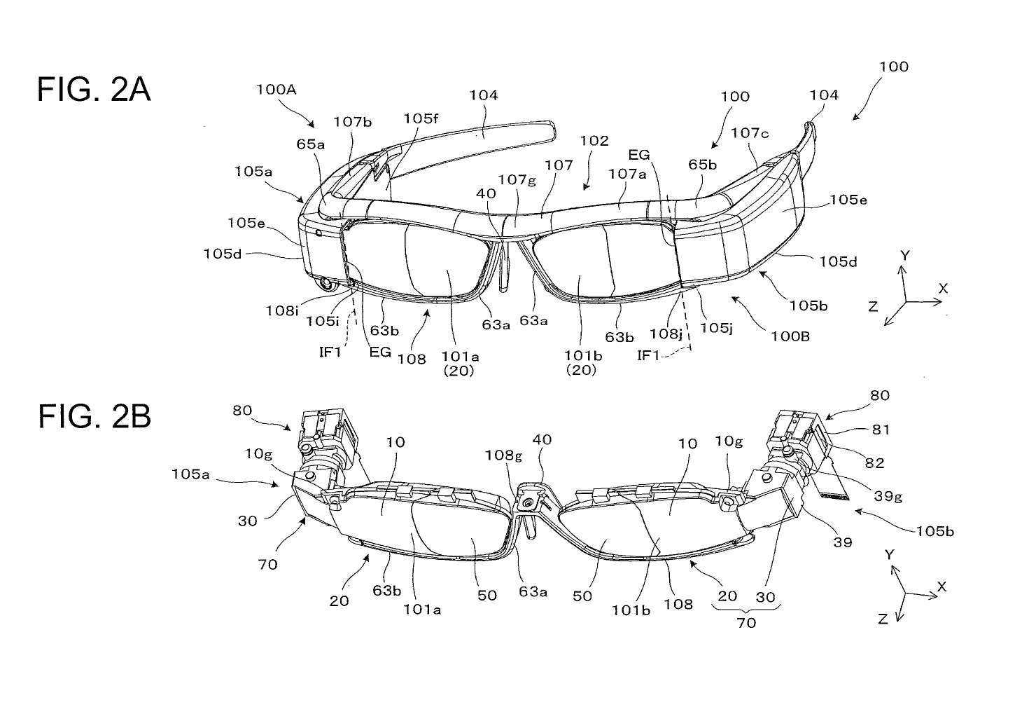

FIG. 2A is a perspective view for explaining the external appearance on the front side of the virtual image display apparatus 100. FIG. 2B is a partially exploded perspective view on the front side of the virtual image display apparatus 100.

As shown in the figures, the frame section 102 provided in the virtual image display apparatus 100 includes a frame 107 arranged on the upper side and a protector 108 arranged on the lower side. In the frame section 102, the frame 107 on the upper side shown in FIG. 2A is an elongated tabular member bent in a U shape in an XZ plane. The frame 107 includes a front surface section 107a extending in the left right lateral direction (an X direction) and a pair of side surface sections 107b and 107c extending in a front back depth direction (a Z direction). The frame 107, that is, the front surface section 107a and the side surface sections 107b and 107c are integral components of metal formed of aluminum die cast or other various metal materials. The width in the depth direction (the Z direction) of the front surface section 107a is sufficiently larger than the thickness or the width of the light guide device 20 corresponding to the first and second optical members 101a and 101b. On the left side of the frame 107, specifically, in a side end portion 65a, which is a portion from the left end portion in the front surface section 107a to the side surface section 107b, the first optical member 101a and the first image forming main body section 105a are aligned and directly fixed by screwing to be supported. On the right side of the frame 107, specifically, in a side end portion 65b, which is a portion from the right end portion in the front surface section 107a to the side surface section 107c, the second optical member 101b and the second image forming main body section 105b are aligned and directly fixed by screwing to be supported. The first optical member 101a and the first image forming main body section 105a are aligned with each other by fitting. The second optical member 101b and the second image forming main body section 105b are aligned with each other by fitting.

The protector 108 shown in FIGS. 2A and 2B is an under rim-like member and arranged and fixed under the frame 107 shown in FIG. 2A. A center section 108g of the protector 108 is fixed to a center section 107g of the frame 107 by fitting and screwing. The protector 108 is an elongated tabular member bent in a two-stage crank shape and integrally formed of a metal material or a resin material. A first distal end portion 108i of the protector 108 is fixed in a state in which the first distal end portion 108i is fit in a recess 105i provided in an outer member 105e of a cover-like armor member 105d configured to cover the first image forming main body section 105a. A second distal end portion 108j of the protector 108 is fixed in a state in which the second distal end portion 108j is fit in a recess 105j provided in an outer member 105e of the cover-like armor member 105d configured to cover the second image forming main body section 105b.

The frame 107 has a role of not only supporting the first and second image forming main body sections 105a and 105b but also protecting the insides of the first and second image forming main body sections 105a and 105b in cooperation with the armor member 105d. The frame 107 and the protector 108 are separated from or loosely in contact with an elliptical circumferential portion of the light guide device 20 excluding a base side coupled to the first and second image forming main body sections 105a and 105b. Therefore, even if there is a difference in a coefficient of thermal expansion between the light guide device 20 in the center and the frame section 102 including the frame 107 and the protector 108, expansion of the light guide device 20 in the frame section 102 is allowed. It is possible to prevent distortion, deformation, and damage from occurring in the light guide device 20.

A nose receiving section 40 is provided incidental to the frame 107. The nose receiving section 40 has a role of supporting the frame section 102 by coming into contact with the nose of the observer. That is, the frame section 102 is arranged in front of the face of the observer by the nose receiving section 40 supported by the nose and the pair of temple sections 104 supported by the ears. The nose receiving section 40 is fixed by screwing in the center section 107g of the front section 107a of one frame 107 configuring the frame section 102 to be held in the center section 108g of the other protector 108 configuring the frame section 102.

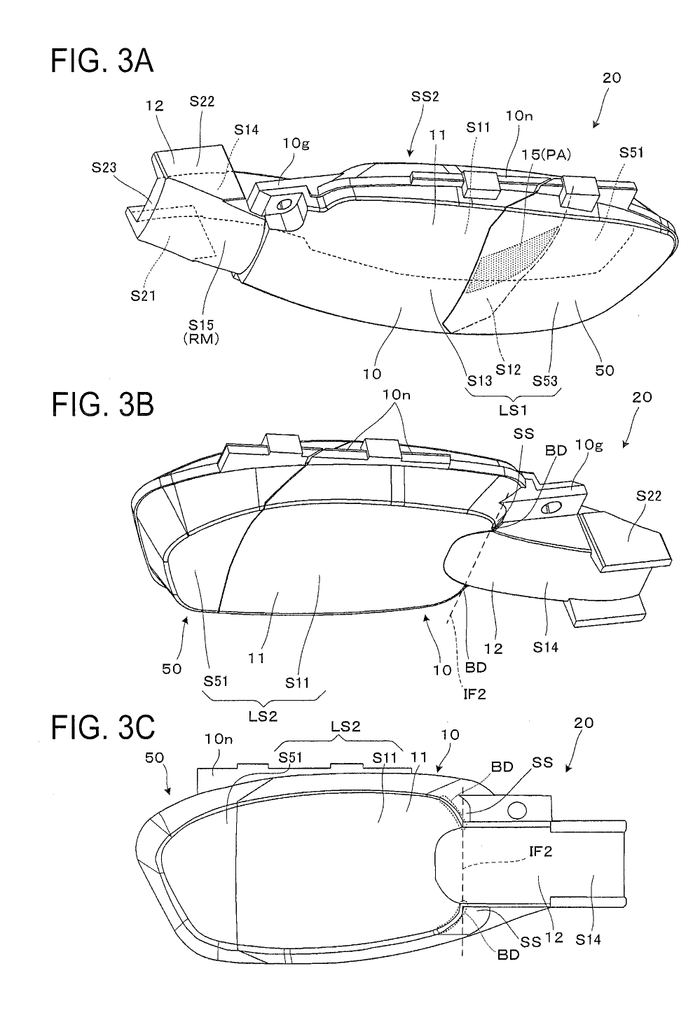

The shape of the light guide device 20 is explained with reference to FIGS. 3A to 3C. As shown in FIGS. 3A and 3B and the like, the light guide device 20 is configured by fixing and integrating a light guide member 10 and a light transmitting member 50 each other. The light guide device 20 is a light transmissive optical block-like or prism-like member. A main body portion surrounded by a peripheral portion includes an elliptical contour and forms an eye front portion when the virtual image display apparatus 100 is worn. The light guide device 20 configured by combining the light guide member 10 and the light transmitting member 50 has a left and right pair configuration (see FIG. 2A and the like). The left and right light guide devices 20 respectively correspond to the first optical member 101a and the second optical member 101b shown in FIG. 1 and form the eye front portion of the virtual image display apparatus 100 formed in an eyeglass shape having a pair of left and right lens-shaped portions. The thickness and the width of the light guide device 20 is about 9 mm.

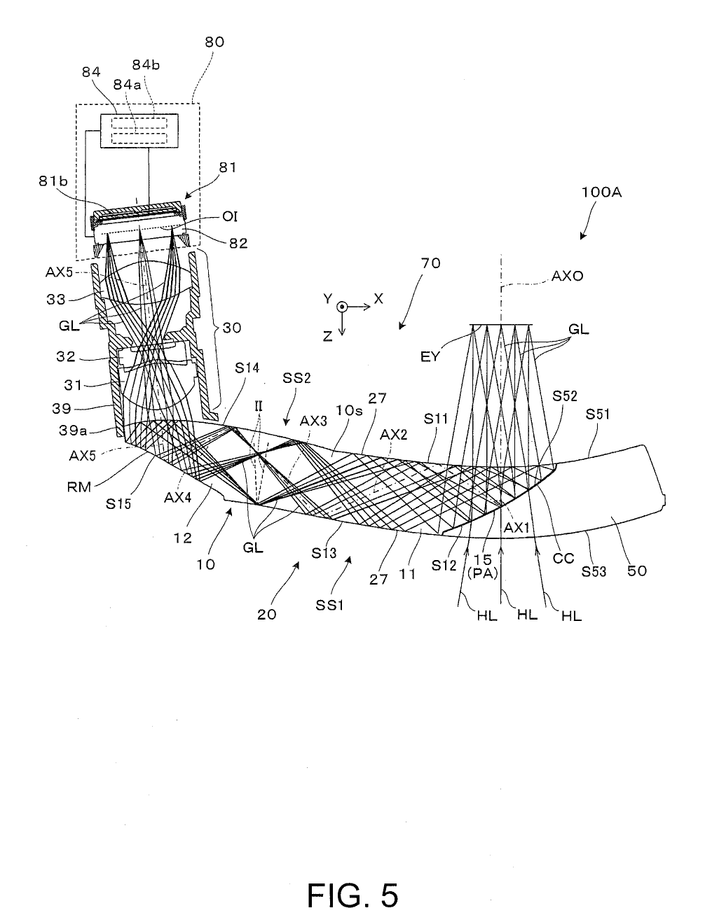

The light transmitting member 50 is arranged in an extending direction of the light guide member 10 to be coupled to a first light guide portion 11 on the distal end side, that is, an emission side or a light emitting side of the light guide member 10. The light transmitting member 50 is fixed to the first light guide portion 11 of the light guide member 10 by joining using an adhesive. As shown in FIG. 3A, among a plurality of surfaces configuring the light guide member 10 and the light transmitting member 50, a third surface S13 of the light guide member 10 and a third transmitting surface S53 of the light transmitting member 50 continuing and adjacent to the third surface S13 form a surface on the front side of the light guide device 20, that is, a lens surface LS1 on a far side from the eyes when the virtual image display apparatus 100 is worn. In other words, the lens surface LS1, a contour shape of which is an eyeglass lens shape, is formed by the third surface S13 and the third transmitting surface S53, which are continuous surfaces. A first surface S11 and a first transmitting surface S51 of the light transmitting member 50 continuing and adjacent to the first surface S11 form a surface on the rear surface of the light guide device 20, that is, a lens surface LS2 on a near side to the eyes when the virtual image display apparatus 100 is worn. In other words, the lens surface LS2, a contour shape of which is an eyeglass lens shape, is formed by the first surface S11 and the first transmitting surface S51, which are continuous surfaces. The lens surfaces LS1 and LS2 are main portions in the eye front portion of the light guide device 20. Optical functions of the light guide member 10 and the optical transmitting member 50 and the surfaces configuring the members are explained in detail with reference to FIG. 5.

The virtual image display apparatus 100 formed similar to the eyeglasses by the sections explained concerning the shapes and the like with reference to FIGS. 1 to 3C is examined from different perspectives. First, when the virtual image display apparatus 100 has a see-through function, for example, as shown in FIG. 1, when the eye front portion of the virtual image display apparatus 100 is viewed from the outside, the frame 107 and the protector 108 of the frame section 102 are considered to form a frame-like region surrounding the eyes of the observer in the eye front portion. As shown in FIG. 1, these members have a function of an opening defining section OR configured to cause the non-observer to feel as if a pseudo open window is present that indicates a region including a first opening width OW1 extending in the lateral direction in which the eyes of the observer range in the eye front portion and a second opening width OW2 extending in the longitudinal direction perpendicular to the lateral direction. A pseudo window formed to surround the eyes, a range of which is indicated by an alternate long and short dash line, by the opening defining section OR configured by end portions and the like of the members arranged around the eyes of the observer as explained above is referred to as pseudo opening window IW. In the case of the HDM having a form similar to the eyeglasses like the virtual image display apparatus 100, the pseudo opening window IW indicates a range viewed from the outside, that is, a range in an external appearance. However, the pseudo opening window IW causes the non-observer to recognize a relative position to the eyes of the observer like rim portions of an eyeglass frame and an eyeglass lens of a normal eyeglasses. When the pseudo opening window IW is recognized like the eyeglass frame and the like, the external appearance of the virtual image display apparatus 100 is good or bad depending on whether the range and the size of the relative position of the pseudo opening window IW to the eyes of the observer are appropriate.

Concerning the external shape of the virtual image display apparatus 100, the position, the range, and the size of the pseudo opening window IW are defined by the armor member 105d, which is the cover-like member, contour portions of the lens surfaces LS1 and LS2 defining the shape of the eye front portion of the light guide device 20, and the like besides the frame section 102 including the frame 107 and the protector 108. In other words, the contour portions of the lens surfaces LS1 and LS2 or the like function as a part of the opening defining section OR forming the pseudo opening window IW. As explained above, when the pseudo opening window IW is recognized as if the pseudo opening window IW is the same as a range recognized by the rim portions of the eyeglass frame and the eyeglass lens, if the shape of the pseudo opening window IW in the virtual image display apparatus 100, that is, the position, the range, and the size of the pseudo opening window IW with respect to the eyes deviate from the shape of the normal eyeglasses, a person other than the observer who looks at the observer wearing the virtual image display apparatus 100 from the outside (also referred to as non-observer; including, for example, the wearer looking at himself/herself in a mirror) feels that the observer wears something strange. For example, when the pseudo opening window IW of the virtual image display apparatus 100 has an extended shape (a wide shape) concerning a portion further on the outer side than the eyes of the observer, that is, the side head side compared with the normal eyeglasses, the non-observer feels as if the eyes of the observer are relatively on the inner side. A sense of discomfort tends to be caused. In order to suppress such a sense of discomfort, concerning the shape (the range) of the pseudo opening window 1W, in particular, concerning the outer side of the eyes of the observer, it is important to cause the non-observer to feel as if a portion (a frame) recognized as a frame is present in an appropriate place.

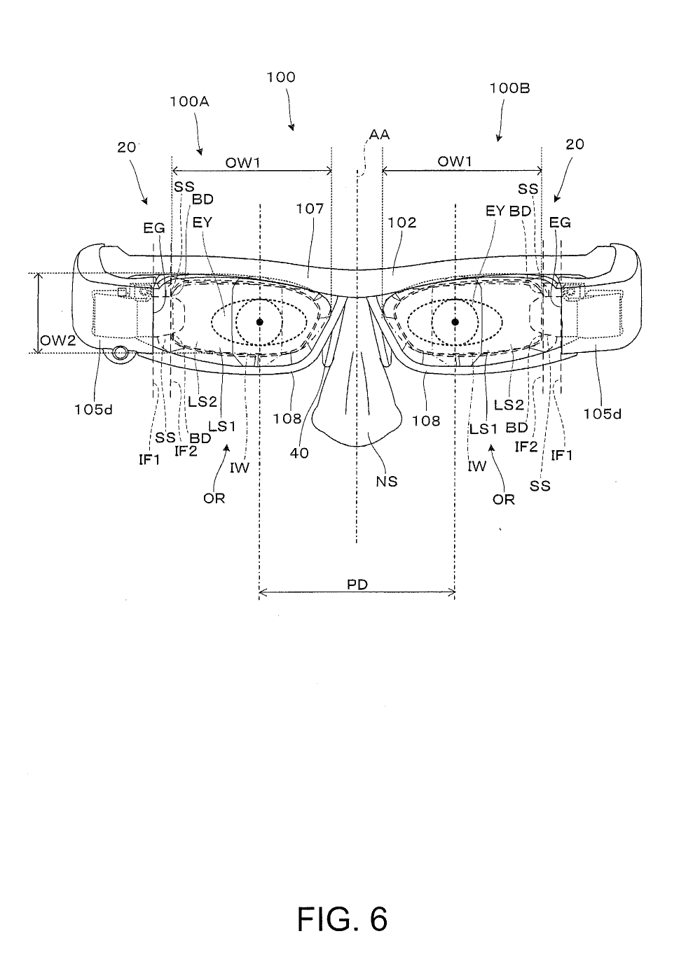

As shown in FIGS. 1 and 2A, the virtual image display apparatus 100 includes, for example, an edge portion EG as an end portion, that is, a boundary portion of the armor member 105d forming a boundary between the lens surface LS1 and the armor member 105d on the front side of the light guide device 20. The edge portion EG, which is the boundary portion, sometimes gives the non-observer an impression as if the edge portion EG is a part of the frame of the virtual image display apparatus 100. That is, the edge portion EG sometime can cause the non-observer to feel as if, as indicated by broken lines in FIGS. 1 and 2A, a frame portion (frame) on an outer side simulating a first frame position IF1, which is a position on the side head side in the eye front portion by the light guide device 20, is a part of the pseudo opening window IW. Further, in the virtual image display apparatus 100, the light guide device 20 is configured by a light transmissive prism-like member in order to realize see-through. Not only the lens surface LS1 on the front side but also the lens surface LS2 on the rear side is visually recognized by the perform looking at the observer from the outside (the non-observer). In particular, as shown in FIGS. 3B and 3C (or FIG. 6), a rim portion BD formed as a portion (a boundary portion) indicating a boundary between the lens surface LS2 and an inclined surface SS formed adjacent to the lens surface LS2 sometimes gives the non-observer an impression as if the rim portion BD is a part of the frame. That is, since the rim portion BID, which is the boundary portion, is present, as indicated by broken lines in FIGS. 3B and 3C, it is sometimes possible to cause the non-observer to feel as if a frame portion (frame) on the outer side simulating a second frame position IF2, which is a position on the side head side in the eye front portion by the light guide device 20 is a part of the pseudo opening window IW. In this embodiment, as candidates of a portion that should be the boundary portion indicating the outer end of the first opening width OW1 in the pseudo opening window IW formed by the opening defining section OR, the virtual image display apparatus 100 includes the edge portion EG and the rim portion BD. Therefore, a visual field for see-through is secured while a sense of discomfort given to the non-observer is suppressed by showing as if, as an external appearance, the outer end of the first opening width OW1 is present further on the inner side in the entire apparatus. In particular, because the virtual image display apparatus 100 is see-through, by causing the non-observer to recognize that the rim portion BD located further on the inner side of the edge portion EG and the rim portion BD, which are the candidates of the boundary portion, as the boundary portion defining the outer end of the pseudo opening window 1W, it is possible to give the non-observer an impression that the position, the range, and the size of the pseudo opening window IW with respect to the eyes are appropriate.

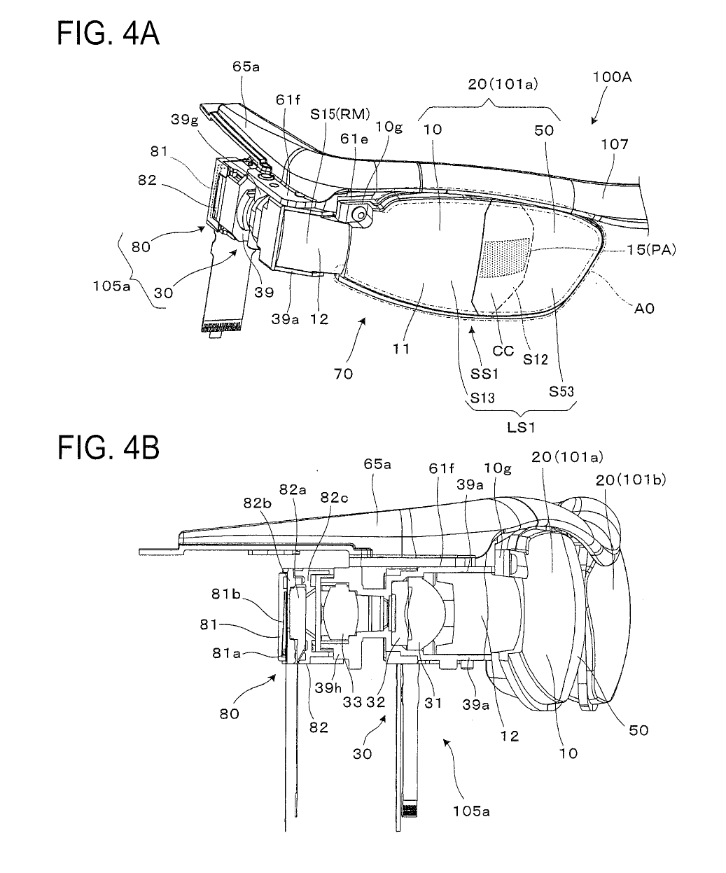

An optical structure in the virtual image display apparatus 100 is explained below with reference to FIGS. 4A and 4B and the like. As shown in FIG. 4A, the first display apparatus 100A can be seen as including a projection see-through device 70, which is an optical system for projection, and an image display device 80 configured to form video light. The projection see-through device 70 has a role of projecting an image formed by the first image forming main body section 105a to the eyes of the observer as a virtual image. The projection transmitting device 70 includes the light guide member 10 for light guide and see-through, the light transmitting member 50 for see-through, and a projection lens 30 for imaging. That is, the first optical member 101a or the light guide device 20 is configured by the light guide member 10 and the light transmitting member 50. The first image forming main body section 105a is configured by the image display device 80 and the projection lens 30.

The image display device 80 and the projection lens 30 configuring the first image forming main body section 105a are explained with reference to FIG. 4B, FIG. 5, and the like.

The image display device 80 includes a lighting device 81 configured to emit illumination light, a video display device 82, which is a transmissive space light modulating device, and a driving control section 84 configured to control the operations of the lighting device 81 and the video display device 82.

The lighting device 81 of the image display device 80 includes a light source 81a configured to generate light including three colors of red, green, and blue and a backlight guide section 81b configured to diffuse light from the light source 81a and change the light to a light beam having a rectangular section. The video display device 82 is formed by, for example, a liquid crystal display device and spatially modulates illumination light emitted from the lighting device 81 and forms image light, which should be a display target such as a moving image. The driving control section 84 includes a light source driving circuit 84a and a liquid crystal driving circuit 84b. The light source driving circuit 84a supplies electric power to the lighting device 81 and causes the lighting device 81 to emit illumination light having stable luminance. The liquid crystal driving circuit 84b outputs an image signal or a driving signal to the video display device 82 to thereby form color video light or image light, which is a base of a moving image or a still image, as a transmissivity pattern. An image processing function can be imparted to the liquid crystal driving circuit 84b. However, the image processing function can also be imparted to an external control circuit.

The projection lens 30 is a projection optical system including three optical devices 31 to 33 as components. The projection lens 30 includes a lens barrel 39 configured to house and support the optical devices 31 to 33. The optical devices 31 to 33 are, for example, aspherical lenses. The optical devices 31 to 33 cooperate with a part of the light guide member 10 to form an intermediate image corresponding to a display image of the video display device 82 on the inside of the light guide member 10. The lens barrel 39 includes a rectangular frame-like engaging member 39a on the front end side. The engaging member 39a fits with a distal end portion on the second light guide portion 12 side of the light guide member 10 to enable positioning of the light guide member 10 with respect to the lens barrel 39.

Details of the functions, the operations, and the like of the projection see-through device 70 are explained with reference to FIG. 5. In the projection see-through device 70, the light guide member 10, which is a part of the light guide device 20, is an arcuate member bent along the face surface in plan view. In the light guide member 10, the first light guide portion 11 is arranged on a center side, that is, a light emission side close to the nose. As side surfaces having an optical function, the first light guide portion 11 includes the first surface S11, the second surface S12, and the third surface S13. The second light guide portion 12 is arranged on a peripheral side, that is, a light incident side apart from the nose. As side surfaces having an optical function, the second light guide portion 12 includes a fourth surface S14 and a fifth surface S15. Among the surfaces, the first surface S11 and the fourth surface S14 are continuously adjacent to each other. The third surface S13 and the fifth surface S15 are continuously adjacent to each other. The second surface S12 is arranged between the first surface S11 and the third surface S13. The fourth surface S14 and the fifth surface S15 are adjacent to each other at a large angle.

In the light guide member 10, the first surface S11 is a free curved surface having an emission side optical axis AX0 parallel to the Z axis as a center axis. The second surface S12 is a free curved surface having an optical axis AX1, which is included in a reference plane (a cross section shown in the figure) parallel to the XZ plane and inclines with respect to the Z axis, as a center axis. The third surface S13 is a free curved surface having the emission side optical axis AX0 as a center axis. The fourth surface S14 is a free curved surface having an optical axis AX5 parallel to a bisector of a pair of optical axes AX3 and AX4, which are included in the reference plane parallel to the XZ plane and incline with respect to the Z axis, as a center axis. The fifth surface S15 is a free curved surface having a bisector of a pair of optical axes AX4 and AX5, which are included in the reference plane parallel to the XZ plane and incline with respect to the Z axis, or a line forming a small angle with the bisector as a center axis. The first to fifth surfaces S11 to S15 have a symmetrical shape in a perpendicular (or longitudinal) Y axis direction across the reference plane (the cross section shown in the figure) that extends horizontally (or laterally) and is parallel to the XZ plane and through which the optical axes AX1 to AX5 and the like pass.

A main body 10s of the light guide member 10 is formed of a resin material showing high light transmissivity in a visible range. The main body 10s is formed by, for example, injecting thermoplastic resin into a mold and solidifying the thermoplastic resin. As the material of the main body 10s, for example, cycloolefin polymer can be used. The main body 10s is an integral molded product. However, the light guide member 10 can be functionally divided into the first light guide portion 11 and the second light guide portion 12 as explained above. The first light guide portion 11 enables wave guide and emission of video light GL and enables transmission of the external light HL. The second light guide portion 12 enables incidence and wave guide of the video light GL.

In the first light guide portion 11, the first surface S11 functions as a refraction surface that emits the video light GL to the outside of the first light guide portion 11 and functions as a total reflection surface that totally reflects the video light GL on the inner surface side. The first surface S11 is arranged in front of an eye EY and is formed in a concave surface shape with respect to the observer. The first surface S11 is a surface formed by a hard coat layer 27 applied to the surface of the main body 10s.

The second surface S12 is the surface of the main body 10s. A half mirror layer 15 is incidental to the surface. The half mirror layer 15 is a reflection film having light transmissivity (i.e., a semi-transmitting reflection film). The half mirror layer (the semi-transmitting reflection film) 15 is formed on a partial area PA where the second surface 12 is narrowed in the vertical direction along the Y axis rather than over the entire second surface S12 (see FIG. 4A). The half mirror layer 15 is formed by forming a metal reflection layer and a dielectric multilayer film on the partial area PA in a base surface of the main body 10s. The reflectance of the half mirror layer 15 to the video light GL is set to 10% or higher and 50% or lower in an assumed incident angle range of the video light GL from the viewpoint of facilitating observation of the external light HL by see-through. The reflective index of the half mirror layer 15 to the video light GL in a specific example is set to, for example, 20%. The transmittance of the half mirror layer 15 to the video light GL is set to, for example, 80%.

The third surface S13 functions as a total reflection surface that totally reflects the video light GL on the inner surface side. The third surface S13 is arranged in front of the eye EY. Like the first surface S11, the third surface S13 is formed in a concave surface shape with respect to the observer. When the external light HL is seen through the first surface S11 and the third surface S13, visibility is substantially zero. The third surface S13 is a surface formed by the hard coat layer 27 applied to the surface of the main body 10s.

In the second light guide portion 12, the fourth surface S14 functions as a total reflection surface that totally reflects the video light GL on the inner surface side. The fourth surface S14 also functions as a refractive surface that makes the video light GL incident in the second light guide portion 12. The fourth surface S14 is a surface formed by the hard coat layer 27 applied to the surface of the main body 10s

In the second light guide portion 12, as explained above, the fifth surface S15 is formed by forming a light reflection film RM formed of an inorganic material on the surface of the main body 10s and functions as a reflection surface.

As explained above, the light transmitting member 50 is fixed integrally with the light guide member 10 to configure the one light guide device 20. The light transmitting member 50 is a member that supports a see-through function of the light guide member 10 (an auxiliary optical block). As side surfaces having an optical function, the light transmitting member 50 includes the first transmitting surface S51, a second transmitting surface S52, and a third transmitting surface S53. The second transmitting surface S52 is arranged between the first transmitting surface S51 and the third transmitting surface S53. The first transmitting surface S51 is present on a curved surface formed by extending the first surface S11 of the light guide member 10. The second transmitting surface S52 is a curved surface joined to and integrated with the second surface S12 by a bonding layer CC. The third transmitting surface S53 is present on a curved surface formed by extending the third surface S13 of the light guide member 10. Among the surfaces, the second transmitting surface S52 and the second surface S12 of the light guide member 10 are integrated by joining via the thin bonding layer CC. Therefore, the second transmitting surface S52 and the second surface S12 have shapes having substantially the same curvatures.

The light transmitting member (the auxiliary optical block) 50 shows high light transmissivity in the visible range. A main body portion of the light transmitting member 50 is formed of a thermoplastic resin material having a refractive index substantially the same as the refractive index of the main body 10s of the light guide member 10. The light transmitting member 50 is formed by joining the main body portion to the main body 10s of the light guide member 10 and then, in a joined state, forming a film together with the main body 20a using hard coat. That is, like the light guide member 10, the hard coat layer 27 is applied to the surface of the main body portion of the light transmitting member 50. The first transmitting surface S51 and the third transmitting surface S53 are surfaces formed by the hard coat layer 27 applied to the surface of the main body portion.

An optical path of the video light GL and the like in the virtual image display apparatus 100 is explained below. The video light GL emitted from the video display device (the video device) 82 is made incident on the fourth surface S14 having positive refractive power provided in the light guide member 10 while being focused by the projection lens 30.

The video light GL passed through the fourth surface S14 of the light guide member 10 travels while converging. When the video light GL passes through the second light guide portion 12, the video light GL is reflected on the fifth surface S15 having relatively weak refractive power, made incident on the fourth surface S14 again from the inner side, and reflected.

In the first light guide portion 11, the video light GL reflected on the fourth surface S14 of the second light guide portion 12 is made incident on the third surface S13 having relatively weak positive refractive power and totally reflected and made incident on the first surface S11 having relatively weak negative refractive power and totally reflected. The video light GL forms an intermediate image in the light guide member 10 before and after the video light GL passes through the third surface S13. An image surface II of the intermediate image corresponds to an image surface OI of the video display device 82.

The video light GL totally reflected on the first surface S11 is made incident on the second surface S12. In particular, the video light GL made incident on the half mirror layer 15 is partially reflected while being partially transmitted, made incident on the first surface S11 again, and passes through the first surface S11. The half mirror layer 15 acts as a layer having relatively strong positive refractive power with respect to the video light GL reflected on the surface. The first surface S11 acts as a surface having negative refractive power with respect to the video light GL that passes through the surface.

The video light GL passed through the first surface S11 is made incident on the pupil of the eye EY of the observer or a position equivalent to the pupil as a substantially parallel light beam. That is, the observer observers an image formed on the video display device (the video device) 82 by the video light GL serving as a virtual image.

On the other hand, in the external light HL, light made incident further on a −X side than the second surface S12 of the light guide member 10 passes through the third surface S13 and the first surface S11 of the first light guide portion 11. At this point, positive and negative refractive powers of the light are offset and aberration of the light is corrected. That is, the observer observes an external image with little distortion through the light guide member 10. Similarly, in the external light HL, light made incident further on a +X side than the second surface S12 of the light guide member 10, that is, light made incident on the light transmitting member 50 passes through the third transmitting surface S53 and the first transmitting surface S51 provided in the light transmitting member 50. At this point, positive and negative refractive powers of the light are offset and aberration of the light is corrected. That is, the observer observes an external image with little distortion through the light transmitting member 50. Further, in the external light HL, light made incident on the light transmitting member 50 corresponding to the second surface S12 of the light guide member 10 passes through the third transmitting surface S53 and the first surface S11. At this point, positive and negative refractive powers of the light are offset and aberration of the light is corrected. That is, the observer observes an external image with little distortion through the light transmitting member 50. Both of the second surface S12 of the light guide member 10 and the second transmitting surface S52 of the light transmitting member 50 have substantially the same curved surface shapes and have substantially the same refractive indexes. A gap between the surfaces is filled by the bonding layer CC having substantially the same refractive index. That is, the second surface S12 of the light guide member 10 and the second transmitting surface S52 of the light transmitting member 50 do not act as a refracting surface with respect to the external light HL.

However, the external light HL made incident on the half mirror layer 15 is partially reflected while being partially transmitted through the half mirror layer 15. Therefore, the external light HL from a direction corresponding to the half mirror layer 15 is weakened to the transmittance of the half mirror layer 15. On the other hand, the video light GL is made incident from a direction corresponding to the half mirror layer 15. Therefore, the observer observes an external image together with an image formed on the video display device (the video device) 82 in the direction of the half mirror layer 15.

In the video light GL propagated in the light guide member 10 and made incident on the second surface S12, light not reflected on the half mirror layer 15 is made incident in the light transmitting member 50. However, the light is prevented from returning to the light guide member 10 by a not-shown reflection preventing section provided in the light transmitting member 50. That is, the video light GL passed through the second surface S12 is prevented from being returned onto the optical path and changing to stray light. The external light HL made incident from the light transmitting member 50 side and reflected on the half mirror layer 15 is returned to the light transmitting member 50. However, the external light HL is prevented from being emitted to the light guide member 10 by the not-shown reflection preventing section provided in the light transmitting member 50. That is, the external light HL reflected on the half mirror layer 15 is prevented from being returned onto the optical path and changing to stray light.

When the video light GL is projected from the video display device (the video device) 82 as explained above, when being worn, the virtual image display apparatus 100 emits image light in a state in which a video optical axis of the video light GL is adjusted at a tilt angle to incline in a direction corresponding to a lower side for the observer from a front view direction corresponding to the front of the eyes of the observer. The front view direction refers to the front direction for the observer. For example, when the observer looks forward while sitting straight or standing, the horizontal direction is the front view direction. That is, for the observer, a direction in a state in which the observer faces straight forward is the front view direction. The eyes of a human are structured to be wide open for observation in the state in which the observer faces straight forward. Therefore, when observation in the state in which the observer faces straight forward continues, a large burden is applied to the eyelids of the observer. Therefore, as shown in FIG. 1 and the like, the virtual image display apparatus 100 in this embodiment is worn to tilt to the downward direction for the observer. As optical design, for example, as shown in FIGS. 3B and 4, the virtual image display apparatus 100 is defined by the image surface OI of the video display device 82, the optical axis AX5 extending perpendicularly to the image surface OI, and the like. When being worn, the virtual image display apparatus 100 is worn to tilt as explained above. Therefore, an image is formed taking the tilt into account. The postures of the members such as the nose receiving section 40 and the temple sections 104 configured to come into contact with the nose and the like of the observer and support the optical system such as the light guide device 20 are adjusted in advance to arrange the virtual image display apparatus 100 such that the optical system such as the light guide device 20 tilts to the lower side for the observer.

FIG. 6 is a front view showing a positional relation between the virtual image display apparatus 100 and the eye EY of the observer. The virtual image display apparatus 100 is an HMD close to the form of the eyeglasses. When the virtual image display apparatus 100 has such an eyeglass-type shape, as explained above, unless the position of the human eye EY is the same as the position in the case of the eyeglasses with respect to the pseudo opening window IW for causing the non-observer to recognize the range of the virtual image display apparatus 100 equivalent to the frame shape of the eyeglasses with respect to the human eye EY, the non-observer looking at the observer wearing the virtual image display apparatus 100 from the outside feels a sense of discomfort. Concerning the form of the eyeglasses, an ideal balance is determined concerning the size and the shape of the eyeglasses because the eyeglasses need to cover the eye sockets in an appropriate range. If the eyeglasses deviate from the shape and the balance, for example, the eyeglasses give an impression that, for example, the eyeglasses do not suit a wearer or the face of the wearer looks strange. The same occurs in the case of the HMD having the form close to the eyeglasses like the virtual image display apparatus 100.

As a method of causing the non-observer to recognize that the virtual image display apparatus 100 has a size and a shape not giving a sense of discomfort when worn like the eyeglasses, in the lateral direction in which the human eyes EY range and the longitudinal direction perpendicular to the lateral direction, the position of the eye EY of the observer and the position of the pseudo opening window IW equivalent to the position of the frame are set in a relatively appropriate range. As a representative value for defining the position of the eye EY of the observer, there is an interpupillary distance. The interpupillary distance means a distance between the centers of the left and right eyes as shown as the reference value PD in FIG. 6. For example, in the case of Japanese, the interpupillary distance is about 62 mm in an average adult female and about 64 mm in an average adult male. An average interpupillary distance or a reference interpupillary distance is set as the reference value PD of the interpupillary distance in optical design (e.g., 63 mm) in advance. The size of the pseudo opening window IW equivalent to the frame of the virtual image display apparatus 100 is defined with respect to the reference value PD of the interpupillary distance in optical design. In particular, in the lateral direction in which the eyes range, the width and the position of the pseudo opening window IW with respect to the position of the eye EY are conspicuous. It is important to set the interpupillary distance in a range in which a sense of discomfort is not caused concerning a positional relation between the eye EY and the pseudo opening window IW because a sense of discomfort concerning the shape and the like can be reduced.

In the configuration of the virtual image display apparatus 100, the light guide device 20 configured to guide video light extends in the lateral direction in which the eyes range and the image display device 80 is arranged on the side head side. Therefore, the entire apparatus tends to increase in size toward the outer side of the eye EY. Further, in the case of see-through as in the virtual image display apparatus 100, there is a demand to create a see-through portion as wide as possible on the outer side in the lateral direction in which the eyes range from the viewpoint of securing a visual field. That is, from the viewpoint of see-through, a configuration is desirable in which the frame is provided on the outer side as much as possible. This is contrary to the configuration in which the frame is formed close to the frame of the eyeglasses.

On the other hand, when the virtual image display apparatus 100 is worn, when there is a linear or bar-like portion having a component in the longitudinal direction perpendicular to the lateral direction in which the eyes range in a position further on the outer side (the side head side) than the eye EY of the observer in the eye front portion of the virtual image display apparatus 100, a person (the non-observer) feels as if the end of the pseudo opening window IW is present as the linear or bar-like portion. For example, in the case of the virtual image display apparatus 100 having the eyeglass shape, as explained above, because not only the edge portion EG of the cover-like armor member 105d shown in FIG. 1 and the like but also the rim portion BD on the outer side of the second lens surface LS2 located further on the inner side (the nose side) than the edge portion EG is present, the non-observer recognizes as if the rim portion BD is the end on the outer side of the pseudo opening window IW in the virtual image display apparatus 100 and recognizes a relative balance of the shape and the size of the pseudo opening window IW with respect to the eye EY with reference to the rim portion BD. Like the edge portion EG and the rim portion BD, a frame arranged, as a part of the opening defining section OR, in a position on the side head side of the observer in the eye front portion of the light guide device 20 and corresponding to the reference value PD of the interpupillary distance of the observer, extending while having a component in the longitudinal direction perpendicular to the lateral direction in which the eyes of the observer range, and defining at least the outer end (an end on the outer side) of the first opening width OW1 in the pseudo opening window IW is referred to as boundary portion or frame display portion to be intentionally displayed. Concerning the boundary portion (the frame display portion), besides the edge portion EG and the rim portion BD, various portions extending while having components in the longitudinal direction could be a target. In the figure, the edge portion EG of the armor member 105d is an end portion of a cover portion that covers a part of the light guide device 20 and is an end portion of an armor case of the optical system. However, an end portion of a part of various cover sections having a shape other than the armor member 105d may function as the boundary portion. As explained above, besides forming the boundary portion using the rim portion BD on the outer side of the lens surface LS2, that is, a ridge line of a surface, the boundary portion may be formed by, for example, intentionally drawing a black line or pattern or forming a portion like a groove. The end of the second opening width OW2 in the pseudo opening window IW is defined by the frame 107 and the protector 108 of the frame section 102, the lens height of the lens surfaces LS1 and LS2 of the light guide device 20, and the like. The inner end (an end on the inner side) of the first opening width OW1 is defined by rim portions on the inner side (the nose side) of the lens surfaces LS1 and LS2, the protector 108, and the like.

As explained above, the edge portion EG of the armor member 105d causes the non-observer to recognize the end on the surface on the front side, that is, the far side from the eye EY in the eye front portion of the light guide device 20 as the first frame position IF1. The rim portion BD causes the non-observer to recognize the end on the surface on the rear side, that is, the near side from the eye EY as the second frame position IF2. Therefore, in order to suppress a sense of discomfort given to the non-observer, it is important that the first frame position IF1 and the second frame position IF2 are present in positions suitable as outer side portions of the frame. In other words, in this embodiment, the edge portion EG in the first frame position IF1 and the rim portion BD in the second frame position IF2 are caused to function as the boundary portion for causing the non-observer to recognize that the outer frame portion is present on the side head side of the light guide device 20. The first and second frame positions IF1 and IF2 indicating the positions where the boundary portion is present are present in appropriate positions according to the reference value PD of the interpupillary distance. Therefore, it is possible to keep a balance of a shape close to the eyeglasses and suppress a sense of discomfort given to the non-observer while securing a visual field range in see-through.

As another idea, making use of see-through, an impression may be given to the non-observer as if the pseudo opening window IW is closer to the inner side by causing the non-observer to recognize, in particular, the second frame position IF2 of the first and second frame positions IF1 and IF2 as the boundary portion (the frame display portion) for displaying the frame for defining the outer end of the pseudo opening window IW, that is, one end on the outer side (the side head side). In this case, a sense of discomfort in terms of a shape can be prevented from easily occurring by causing the non-observer to recognize the outer end of the pseudo opening window IW in the second frame position IF2 while securing a wide visual field slightly wider in the first frame position IF1 indicating a limit of a visual field of the observer by see-through.

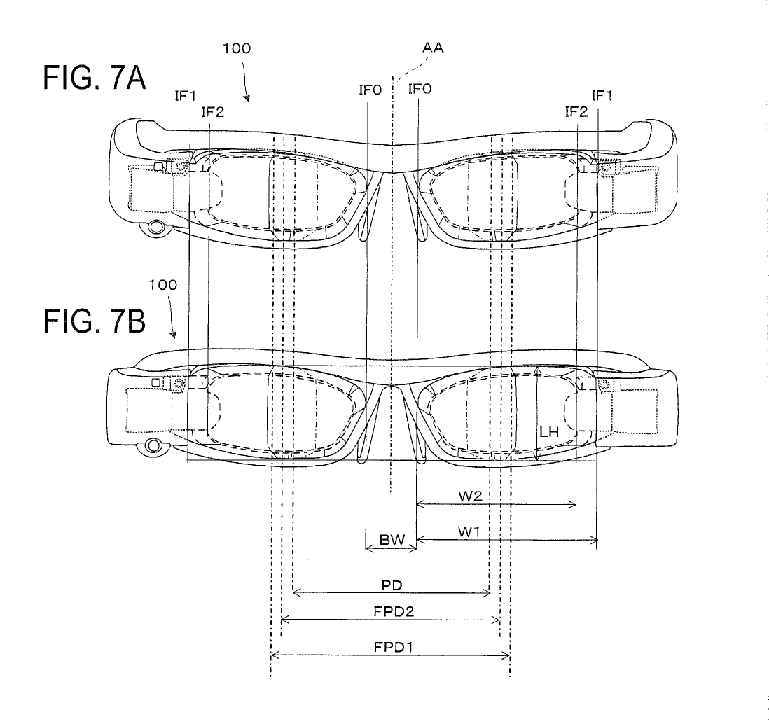

Dimensions in the virtual image display apparatus 100 including the light guide device 20 provided with the boundary portion are explained in detail below with reference to FIGS. 7A and 7B. Then, definition of a range for not causing a sense of discomfort is explained. FIG. 7A is a front view of a wearing state of the virtual image display apparatus 100. FIG. 7B is a front view of an optical reference of the virtual image display apparatus 100.

As explained above, the virtual image display apparatus 100 emits image light in a state in which a video optical axis of the video light GL is adjusted at a tilt angle to incline in a direction corresponding to a lower side for the observer from a front view direction corresponding to the front of the eyes of the observer. Therefore, the virtual image display apparatus 100 is worn in a state in which the virtual image display apparatus 100 further inclines downward toward the front side. Therefore, in the front view of the wearing state shown in FIG. 7A and the front view of the optical reference shown in FIG. 7B, directions are slightly different. In view of the above, in this embodiment, the virtual image display apparatus 100 is configured not to cause a sense of discomfort in the non-observer not only in a posture in the front view of the optical reference shown in FIG. 7B but also in a posture in an actual wearing state shown in FIG. 7A.

The sizes and the shapes of the sections in the eye front portion of the light guide device 20 in this embodiment are specifically explained below with reference to FIGS. 7A and 7B. First, as shown in FIGS. 7A and 7B, in the virtual image display apparatus 100, width between a pair of the light guide devices 20 arranged symmetrically with respect to a center axis AA passing through the center portion in the horizontal direction (the left right direction), which is the lateral direction in which the eyes range, that is, a bridge width is represented as BW. As shown in the figure, the bridge width BW is a distance between lens positions IF0 on the inner side (the nose side), which are positions at distal end portions in the pair of left and right light guide devices 20. The lens position IF0 is also a position defining the outer end of the first opening width OW1 (see FIG. 6) in the pseudo opening window IW. In the light guide device 20, concerning the eye front portion having the lens shape, the lens width of the first lens surface is represented as first lens width W1 and the lens width of the second lens surface is represented as second lens width W2. The first lens width W1 is a distance from the lens position IF0 to the first frame position IF1. The second lens width W2 is a distance from the lens position IF0 to the second frame position IF2. The shape of the lens surfaces LS1 and LS2 are adjusted such that there is no difference in the first lens width W1 and the second lens width W2 between the state shown in FIG. 7A and the state shown in FIG. 7B. Therefore, for example, a chamfer angle of the inclined surface SS, which is a surface connecting the first lens surface LS1 and the second lens surface LS2, is adjusted.

Further, in the virtual image display apparatus 100, an inter-lens center distance (a first frame PD) concerning the first lens surface of the light guide device 20 is represented as first inter-lens center distance FPD1 and an inter-lens center distance (a second frame PD) concerning the second lens surface is represented as second inter-lens center distance FPD2.

In this case, the first inter-lens center distance FPD1 is represented by a sum of the bridge width BW and the lens width W1. That is,

FPD1=BW+W1 (1).

Similarly, the second inter-lens center distance FPD2 is represented by a sum of the bridge width BW and the lens width W2. That is,

FPD2=WB+W2 (2).

In the virtual image display apparatus 100, the lens height of the light guide device 20 is represented as LH. The height LH is width in the longitudinal direction perpendicular to the lateral direction (width in a direction perpendicular to the lens width W1) and means a maximum width of the first lens surface LS1.

The definition of the bridge width BW, the lens widths W1 and W2, the inter-lens center distances FPD1 and FPD2, and the lens height LH can be considered values defined by a method equivalent to a method for defining a bridge width and the like in defining sizes concerning the frame of the normal eyeglasses. However, in the case of the normal eyeglass, the lens portion is thin unlike the light guide device 20 of the virtual image display apparatus 100. Therefore, for example, the lens width is normally indicated by one value without distinction of the front side (a first lens surface side) and the rear side (a first lens surface side). On the other hand, in the light guide device 20, as explained above, the thickness or the width from the first lens surface LS1 to the second lens surface LS2 is about 9 mm, which is larger than the thickness of the normal eyeglass lens. Therefore, it is possible to change the size and the shape of the second lens surface LS2 with respect to the size and the shape of the first lens surface LS1 by giving a chamfer angle to the surface connecting the first lens surface LS1 and the second lens surface LS2. In other words, concerning the lens widths and the like, on the front side (the first lens surface side) and the rear side (the first lens surface side), a difference is set between the first lens surface LS1 and the second lens surface LS2 to a degree that the lens surfaces can be individually defined.

It is desirable that, specifically, the following conditions are satisfied concerning the values of the virtual image display apparatus 100 defined as explained above.

5 mm≦BW≦20 mm (3)

40 mm≦W1≦70 mm (4)

40 mm≦W2≦60 mm (5)

FPD1−PD≦10 mm (6)

FPD2−PD≦10 mm (7)

20 mm≦LH≦45 mm (8)

As explained above, concerning the form of the eyeglasses, the eyeglasses need to cover the eye sockets in an appropriate range. Therefore, there is an ideal balance of the sizes and the shapes naturally acceptable by a human sense as natural without a sense of discomfort. The conditional expressions are one of references of the balance. That is, by configuring the virtual image display apparatus 100 to satisfy the conditional expressions, it is possible to prevent the virtual image display apparatus 100 from causing a sense of discomfort when the virtual image display apparatus 100 is considered as the eyeglasses in the shape. Further, to recognize the virtual image display apparatus 100 as having a more natural shape, it is preferable to satisfy conditions (6-1) and (7-1) shown below obtained by setting stricter conditions for Expressions (6) and (7).

FFD1−PD≦4 mm (6-1)

FPD2—PD≦4 mm (7-1)

As another idea, it is also conceivable to define only Expression (7) or (7-1) of Expressions (6) and (7) or (6-1) and (7-1). For example, as shown in FIG. 6, the inclined surface SS, which is a surface located on the side head side of the observer, in the surface connecting the first lens surface LS1 and the second lens surface LS2 is machined at a chamfer angle from the first lens surface LS1 to the second lens surface LS2 to incline from the side head side (the outer side) to the nose NS side (the inner side) of the observer.

Since the inclined surface SS is given the chamfer angle in this way, a difference is set between the position (the first frame position IF1) of the edge portion EG, which is a rim portion of the first lens surface LS1, and the position (the second frame position IF2) of the rim portion BD of the second lens LS2. From another perspective, when the virtual image display apparatus 100 is viewed at least from the front as shown in FIG. 6, the second lens surface LS2 is set in a narrower range than the first lens surface LS1. In this case, the rim portion BD of the second lens surface LS2 present further on the inner side than the first lens surface LS1 is present in an appropriate position (e.g., a position where Expression (7) is satisfied, more preferably, a position where Expression (7-1) is satisfied) and functions as the boundary portion (the frame display portion) for displaying the frame on the outer side of the pseudo opening window IW. Consequently, it is possible to cause the non-observer to recognize that the pseudo opening window IW is in a position, a range, and a size not causing a sense of discomfort. On the other hand, a visual field range can be secured by setting the position of the edge portion EG, which indicates a limit of the visual field range in see-through, slightly wider on the peripheral side of the first lens surface LS1 present further on the outer side than the second lens surface LS2.

Besides, concerning Expression (3), the range of the bridge width BW is defined to prevent, for example, a visual filed from being divided to the left and right while securing a visual field on the inner side (the nose side) in see-through. A state in which the eye sockets are appropriately covered in the center portion is maintained to prevent, for example, an interval in the center from excessively increasing to give the non-observer an impression of a flat face. Concerning Expression (8), by defining the range of the lens height LH, for example, when the virtual image display apparatus 100 is worn over the eyeglasses, it is possible to suppress a sense of discomfort due to the presence of the eyeglasses worn under the virtual image display apparatus 100 and prevent a sense of discomfort concerning an aspect ratio when the virtual image display apparatus 100 is viewed from the front.

In the virtual image display apparatus 100, the rim portion BD or the like functioning as the boundary portion is arranged in the position corresponding to the interpupillary distance of the observer. Therefore, it is possible to cause the non-observer looking at the observer wearing the virtual image display apparatus 100 from the outside to recognize that the outer frame portion is present in an appropriate position in terms of the eyeglass shape. It is possible to reduce a sense of discomfort given to the non-observer. Since the boundary portion is present in an appropriate position in terms of an eyeglass shape, a visual field same as a visual field obtained when the eyeglasses are worn is secured. Therefore, it is possible to sufficiently secure a visual field range for the observer in see-through.

The invention is explained above according to the embodiment. However, the invention is not limited to the embodiment and can be carried out in various forms without departing from the spirit of the invention.

In the above explanation, the virtual image display apparatus 100 including the pair of display apparatuses 100A and 100B is explained. However, the virtual image display apparatus 100 can include a single display apparatus. That is, rather than providing one set of the projection see-through device 70 and the image display device 80 for each of the right and left eyes, the projection see-through device 70 and the image display device 80 may be provided for one of the right and left eyes to view an image with one eye. In this case, concerning values equivalent to Expressions (1) to (8), a reference position corresponding to the center position indicated by the center AA in FIG. 6 only has to be defined on the basis of a position assuming the center of the nose NS. Half values of the values indicated by Expressions (1) to (3), (6), and (7) only have to be defined as references to manufacture the virtual image display apparatus 100. Concerning Expressions (4), (5), and (8), the expressions can be applied as they are. In this case, the frame 107 and the temple sections 104 are formed in a shape arranged symmetrically as shown in FIG. 1 and the like.

In the embodiment, in the image display device 80, the video display device 82 including the transmissive liquid crystal display device is used. However, the image display device 80 is not limited to the video display device 82 including the transmissive liquid crystal display device. Various image display devices can be used. For example, an image display device including a reflective liquid crystal display device is also possible. A digital micro mirror device or the like can be used instead of the video display device 82 including the liquid crystal display device. As the image display device 80, an self-emitting device represented by an LED array, an OLED (organic EL), and the like can be used.

Fixing of the light guide device 20 and the projection lens 30 is not limited to the fastening by screwing. The light guide device 20 and the projection lens 30 can be fixed to the frame 107 by various methods.

In the embodiment, the engaging member 39a with the light guide device 20 is provided in the lens barrel 39 of the projection lens 30. However, an engaging member fitting with the lens barrel 39 can be provided to, for example, hold the lens barrel 39 on the light guide device 20 side.

In the embodiment, the half mirror layer (the semi-transmitting reflection film) 15 is formed in the laterally long rectangular region. However, the contour of the half mirror layer 15 can be changed as appropriate according to an application and the like. The transmittance and reflectance of the half mirror layer 15 can also be changed according to an application and the like.

In the embodiment, the half mirror layer 15 is the mere semi-transmissive film (e.g., the metal reflection film or the dielectric multilayer film). However, the half mirror layer 15 can be replaced with a hologram device having a flat surface or a curved surface.

In the embodiment, the distribution of the display luminance in the video display device 82 is not particularly adjusted. However, for example, when a luminance difference occurs depending on a position, the distribution of the display luminance can be unequally adjusted.

In the embodiment, on the first surface S11 and the third surface S13 of the light guide member 10, video light is totally reflected by an interface with the air without applying a mirror, a half mirror, or the like on the surfaces. However, the total reflection in the virtual image display apparatus 100 according to the invention includes reflection performed by forming a mirror coat or a half mirror film on the entire first surface S11 or third surface S13 or a part of the first surface S11 or the third surface S13. For example, the total reflection also includes reflection of substantially all video light performed by applying a mirror coat or the like to the entire first surface S11 or third surface S13 or a part of the first surface S11 or the third surface S13 on condition that an incident angle of the video light satisfies all reflection conditions. If video light having sufficient brightness is obtained, the entire first surface Sli or third surface S13 or a part of the first surface Sli or the third surface S13 may be coated with a mirror having slight transmissivity.

In the above explanation, the light guide member 10 and the like extend in the lateral direction in which the eyes EY range. However, the light guide member 10 can be arranged to extend in the longitudinal direction. In this case, the light guide member 10 is supported by, for example, an cantilever state in an upper part.

The first surface S11 and the third surface S13 arranged to be opposed to each other are formed in the concave surface shape with respect to the observer. However, the first surface S11 and the third surface S13 may be formed in a parallel plane shape. In this case, visibility can be set to 0 when the observer views the outside world through the first surface S11 and the third surface S13. When the first surface S11 and the third surface S13 have the parallel plane shape, for example, the surfaces other than the first surface S11 and the third surface S13 may be formed as a curved surfaces to form an intermediate image. Alternatively, the intermediate image does not have to be formed.

The entire disclosure of Japanese Patent Application No. 2013-096199, filed May 1, 2013 is expressly incorporated by reference herein.

What is claimed is:

1. A virtual image display apparatus comprising:
a video device;
a light guide device arranged in front of eyes of an observer and configured to guide light emitted by the video device to the eyes of the observer and cause the observer to visually recognize an image; and
an opening defining section provided to correspond to the light guide device and configured to define a region having a first opening width extending in a lateral direction in which the eyes of the observer range and a second opening width extending in a longitudinal direction perpendicular to the lateral direction, enable the eyes of the observer to be visually recognized from an outside, and cause the observer to visually recognize a relative position to the eyes of the observer, wherein
the virtual image display apparatus includes, as at least a part of the opening defining section, a boundary portion arranged in at least a position on a side head side of the observer in the lateral direction in which the eyes of the observer range, the position being derived from a reference value of an interpupillary distance of the observer, extending while having a component in the longitudinal direction perpendicular to the lateral direction in which the eyes of the observer range, and configured to define an outer end of the first opening width.

2. The virtual image display apparatus according to claim 1, wherein, in an eye front portion of the light guide device, the boundary portion is formed on a surface on a side close to the eyes of the observer when the virtual image display apparatus is worn.

3. The virtual image display apparatus according to claim 1, wherein
the light guide device includes a contour portion serving as an eyeglass lens-like shape having a predetermined thickness and includes a first lens surface located on a side far from the eyes of the observer when the virtual image display apparatus is worn and a second lens surface located on a side close to the eyes, and
the boundary portion is configured by a rim portion serving as a boundary between the second lens surface and a surface adjacent thereto on the side head side of the observer in a contour portion of the second lens surface.

4. The virtual image display apparatus according to claim 3, wherein the light guide device includes a pair of eyeglass lens-like shape portions symmetrical with respect to a center axis passing a center section arranged in a position of a nose of the observer when the virtual image display apparatus is worn and satisfies a following conditional expression concerning an inter-lens center distance FPD2 concerning the second lens surface represented by a sum of a bridge width BW, which is an inter-lens distance in the symmetrical pair of eyeglass lens-like shape portions, and a lens width W2 of the second lens surface and a reference value PD of the interpupillary distance of the observer:
FPD2−PD10 mm

5. The virtual image display apparatus according to claim 4, wherein the light guide device satisfies all of following conditional expressions concerning a bridge width BW, a lens width W1 of the first lens surface, a lens width W2, an inter-lens center distance FPD1 concerning the first lens surface represented by a sum of the bridge width BW and the lens width W1, and the reference value PD of the interpupillary distance of the observer:
5 mm≦BW2≦20 mm
40 mm≦W1≦70 mm
40 mm≦W2≦60 mm
FPD1−PD≦10 mm.

6. The virtual image display apparatus according to claim 3, wherein the light guide device satisfies a following conditional expression concerning a lens height LH:
20 mm≦LH≦45 mm.

7. The virtual image display apparatus according to claim 3, wherein
in the light guide device, a surface located on the side head side of the observer in a surface connecting the first lens surface and the second lens surface is an inclined surface machined at a chamfer angle from the first lens surface to the second lens surface to incline from the side head side to the nose side of the observer, and
a rim portion on the side head side of the observer in the first lens surface is located further on an outer side than the rim portion on the side head side of the observer in the second lens surface.

8. The virtual image display apparatus according to claim 7, wherein
the light guide device emits a video light in a state in which a video optical axis of the video light is adjusted at a tilt angle to tilt in a direction corresponding to a lower side for the observer from a front view direction corresponding to a front of the eyes of the observer, and
in the light guide device, the chamfer angle is adjusted according to the tilt angle.

9. The virtual image display apparatus according to claim 1, wherein the opening defining section includes a member arranged to surround the eyes of the observer and forms, with the member, a pseudo opening window, which is pseudo window indicating a region having the first and second opening widths.

10. The virtual image display apparatus according to claim 1, wherein the boundary portion includes any one of an end portion of a cover section configured to house a part of the light guide device, an end portion of an armor case, and a portion serving as a boundary between a plurality of surfaces forming a surface of the light guide device.

11. The virtual image display apparatus according to claim 1, further comprising:
a frame section including a frame extending in the lateral direction in which the eyes of the observer range and configured to support the light guide device from an upper side; and
a protector extending in the lateral direction in which the eyes of the observer range and configured to support the light guide device from a lower side, the frame section defining at least a part of the second opening width with the frame and the protector.

12. The virtual image display apparatus according to claim 1, wherein the light guide device includes:
a light guide member forming a half mirror surface and configured to reflect light emitted from the video device to the eyes of the observer; and
a light transmitting member arranged integrally with the light guide member on the outer side of the half mirror surface and configured to set visibility to external light to about 0 and present the external light and video light to the observer to be superimposed.
